(19) United States
(12) Patent Application Publication
(10) Pub. No.: US 2018/0157268 A1
(43) Pub. Date: Jun. 7, 2018

(54) TAXI CLIENT IDENTIFICATION FOR AUTOMATED VEHICLES

(71) Applicant: Delphi Technologies, Inc., Troy, MI (US)

(72) Inventors: Nandita Mangal, Palo Alto, CA (US); Michael H. Laur, Mission Viejo, CA (US)

(21) Appl. No.: 15/369,989

(22) Filed: Dec. 6, 2016

(51) Int. Cl. G05D 1/02; G05D 1/00; G06K 9/00; G06F 3/01; G06T 7/73

(52) U.S. Cl. CPC G05D 1/0246; G05D 1/0088; G06K 9/00791; G06T 2207/30252; G06T 7/74; G05D 2201/0212; G06T 2207/30196; G06F 3/017

(57) ABSTRACT

An automated-taxi client identification system for automated vehicles includes a communications-network, a camera, and a controller. The communications-network is used to send a transportation-request from a client to an automated-taxi, and communicate an identification-code to be displayed by the client. The camera is used by the automated-taxi to capture an image of a pickup-zone. The controller is in communication with the camera and the communications-network. The controller determines when the identification-code is detected in the image and determines a location of the client based on a position of the identification-code in the image.

### TECHNICAL FIELD OF INVENTION

This disclosure generally relates to an automated-taxi client identification system, and more particularly relates to a system that determines a location of a client based on a position in an image of an identification-code displayed by the client.

### BACKGROUND OF INVENTION

When a person, i.e. client, requests or makes a reservation for a taxi, it may be difficult for an automated-taxi (or operator of a partially-automated-taxi) to identify the client if the client is in a crowd of people.

### SUMMARY OF THE INVENTION

In accordance with one embodiment, an automated-taxi client identification system for automated vehicles is provided. The system includes a communications-network, a camera, and a controller. The communications-network is used to send a transportation-request from a client to an automated-taxi, and communicate an identification-code to be displayed by the client. The camera is used by the automated-taxi to capture an image of a pickup-zone. The controller is in communication with the camera and the communications-network. The controller determines when the identification-code is detected in the image and determines a location of the client based on a position of the identification-code in the image.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a diagram of an automated-taxi client identification system in accordance with one embodiment;

FIG. 2 is an illustration of a personal-communication-device used by the system of FIG. 1 in accordance with one embodiment;

FIGS. 3A and 3B are graphs of signals present in the system of FIG. 1 in accordance with one embodiment;

FIG. 4 is an illustration of a client interacting with the system of FIG. 1 in accordance with one embodiment; and

FIG. 5 is graph of a waving pattern performed by the client when interacting with the system of FIG. 1 in accordance with one embodiment.

### DETAILED DESCRIPTION

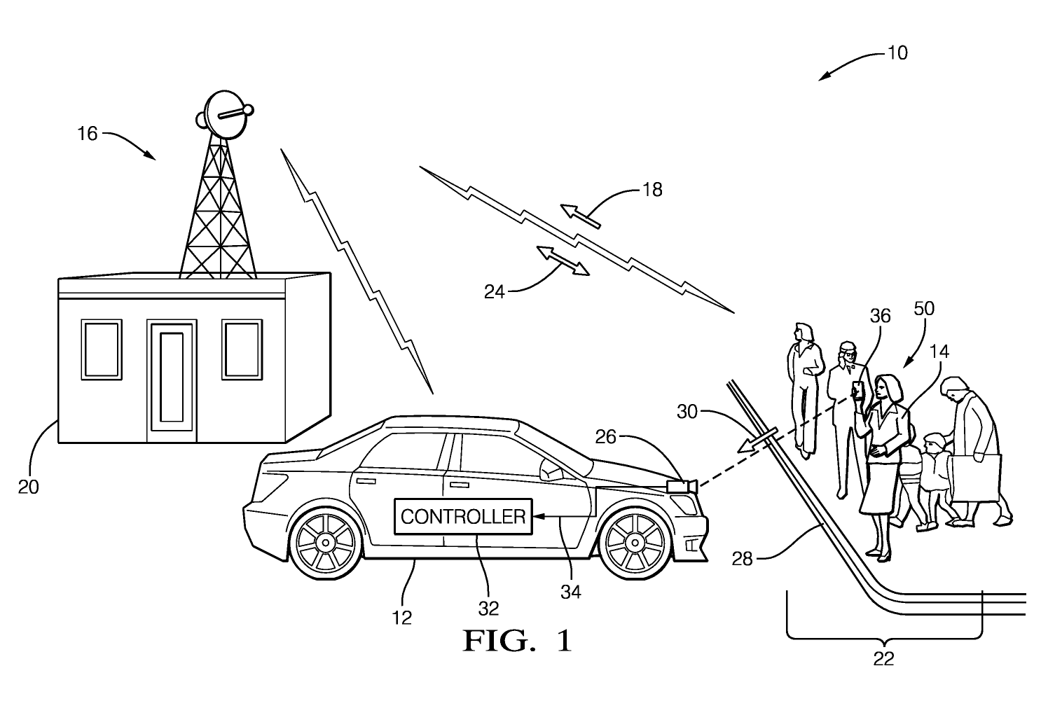

FIG. 1 illustrates a non-limiting example of an automated-taxi client identification system 10, hereafter referred to as the system 10, which is generally suitable for use by automated vehicles, in particular an automated-taxi 12. As used herein, the term automated vehicle may apply to instances when the automated-taxi 12 is being operated in an automated-mode, i.e. a fully autonomous mode, where there may not be a human-operator that drives the automated-taxi. However, full automation is not a requirement. It is contemplated that the teachings presented herein are useful when the automated-taxi 12 is operated in a partially or fully manual-mode where the degree or level of automation may be, for example, little more than providing assistance to a human-operator (not shown) with finding a particular instance of a client 14. That is, a human-operator (other than the client) may generally be in control of the steering, accelerator, and brakes of the automated-taxi 12.

The system 10 includes a communications-network 16 used to send a transportation-request 18 from the client 14 to the automated-taxi 12. The communications-network 16 may employ any combination of known communication means such as, but not limited to, a web-site accessed via an internet-server (not shown), a cellular-phone-network using voice and/or data communications, and/or a private radio network for communications between a dispatch-center 20 and the automated-taxi 12. The transportation-request 18 may include, but is not limited to, an address where the client 14 is to be picked-up, a destination, a desired pickup-time and/or desired-arrival-time, a luxury-level (e.g. limousine vs. standard taxi), and/or the number of passengers to be transported.

When the client 14 is at a location or a pickup-zone 22 where many people are gathered, near a baggage claim at an airport or along a pedestrian filled sidewalk for example, the automated-taxi 12 may not be able to distinguish the client 14 from the crowd. To overcome this problem, the communications-network 16 is advantageously used to communicate an identification-code 24 to be displayed by the client 14. As used herein, the identification-code 24 may be any of many possible actions or means that could be displayed by the client 14 so the client 14 is readily distinguished from a crowd of people. As suggested by the two-way arrow used to indicate the identification-code 24, the identification-code 24 could be specified by the client 14, or specified by the dispatch-center 20, or specified by the automated-taxi 12. By way of example and not limitation, the identification-code 24 may be a physical gesture performed by the client 14, or a sign or symbol held by the client 14, or any of several other possibilities, some of which will be described in more detail below. Once the automated-taxi 12 ‘knows’ where the client 14 is located, the automated-taxi 12 can approach and stop as close as possible to the client 14 thereby making it as easy as possible for the client 14 to board the automated-taxi 12.

The system 10 includes a camera 26 used by the automated-taxi 12 to capture an image 34 of a pickup-zone 22, which is where it is expected that the client 14 will be meeting the automated-taxi. By way of example and not limitation, the pickup-zone may be an area specified by the government or proprietor of an establishment, or it may be a dynamically defined area such as along a curb 28 of a section of roadway that is within a defined distance (e.g. fifty meters) from an address. The camera 26 is preferably a video type camera so a sequence of images can be analyzed by the system 10 to determine when the identification-code 24 is displayed 30 by the client 14. As suggested above, various examples of what constitutes the identification-code 24 will be described later.

The system 10 includes a controller 32 in communication with the camera 26 and the communications-network 16. The controller 32 may include a processor (not specifically shown) such as a microprocessor or other control circuitry such as analog and/or digital control circuitry including an application specific integrated circuit (ASIC) for processing data as should be evident to those in the art. The controller 32 may include memory (not specifically shown), including non-volatile memory, such as electrically erasable programmable read-only memory (EEPROM) for storing one or more routines, thresholds, and captured data. The one or more routines may be executed by the processor to perform steps for when the identification-code 24 is detected in the image 34 and determines a location 50 of the client 14 relative to the automated-taxi 12 based on a position of the identification-code in the image 34. Those in the art will recognize that the two-dimensional position of the identification-code 24 in the image 34 can be transposed into the three-dimensions that correspond to the area about the automated-taxi 12 using well-known transposition techniques.

While FIG. 1 suggests that the camera 26 and controller 32 are installed on the automated-taxi, this is not a requirement. It is contemplated that the controller could be located at the dispatch center, or at some other remote location. Similarly, the camera 26 may be part of an imaging system that has numerous cameras located various suitable pickup-zones, where at least one of those numerous cameras as a field-of-view that covers the pickup-zone 22.

In one embodiment, the identification-code 24 may be displayed on a personal-communication-device 36 (e.g. smart-phone, tablet, smart-sign) operated or held by the client 14. That is, the identification-code 24 may be communicated to or programmed in the personal-communication-device 36 in preparation for the arrival of the automated-taxi 12. Then when the automated-taxi 12 locates whatever is being displayed on the personal-communication-device 36, the automated-taxi may approach and stop next to or as close as possible to the personal-communication-device 36.

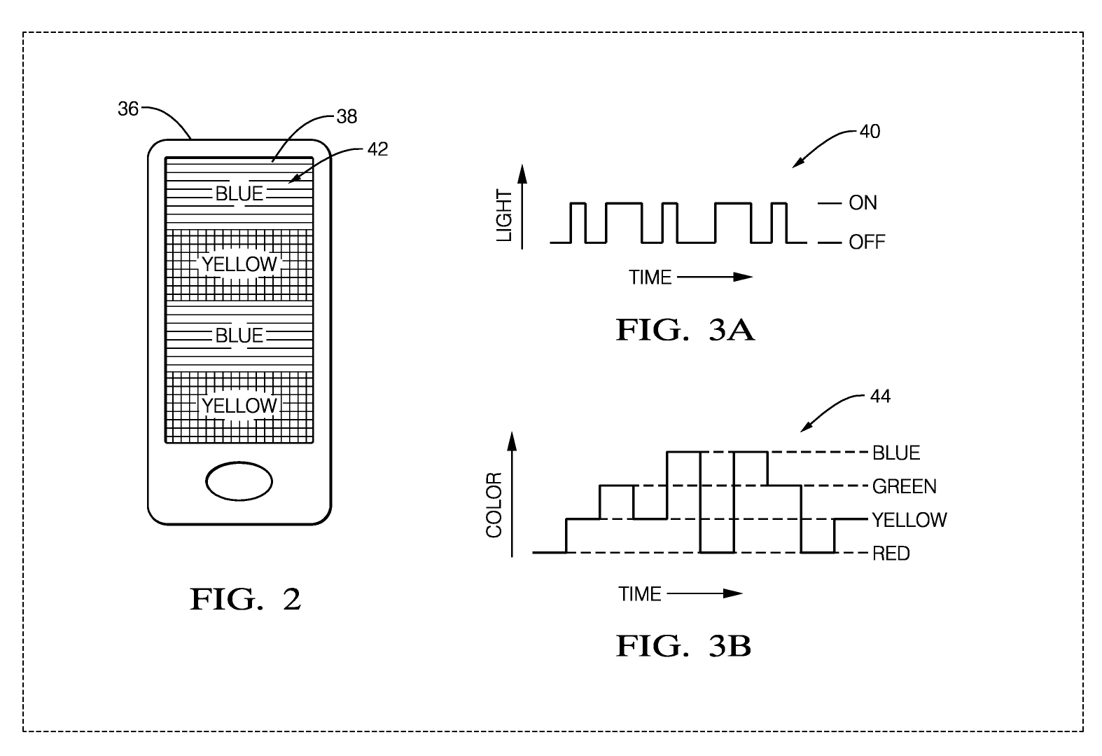

FIG. 2 illustrates a non-limiting example of the personal-communication-device 36, a smart-phone, that includes a display 38 on which the identification-code 24 can be displayed. By way of example and not limitation, the identification-code 24 may be a light-pulse-sequence 40 (FIG. 3A) where an alternating ON/OFF pattern of light is displayed, possibly corresponding to Morse code. Alternatively, the display 38 may simply show a color (not shown in the figures), where the display 38 is illuminated with a steady red, yellow, or blue light for example. Alternatively, the display 38 may show a color-pattern 42 (FIG. 2) on the display 38 such as alternating bands of blue and yellow. Alternatively, the display 38 may show a color-sequence 44 (FIG. 3B), i.e. a timed sequence of different colors. It is contemplated that some of these examples may be combined. For example, various portions of the display 38 indicated by the color-pattern 42 may be varied according to various patterns, not necessarily the same as, but possibly comparable to, the color-sequence 44.

Instead of using the personal-communication device 36 to display the identification-code 24, a reconfigurable-display (not shown, but likely simpler function/capability than a typical example of the personal-communication device 36) may be used to display the identification-code 24. For example, reconfigurable-displays may be distributed along the pickup-zone 22, and each of the reconfigurable-displays may be programed or operated by the client to display the identification-code 24. It is also contemplated that an instance of the reconfigurable-display may be attached to or built into (i.e. integrated into) well-known travel equipment such as suitcase, backpack, or briefcase. This would allow the client 14 to stand beside or near the travel equipment while waiting for the automated-taxi 12 to arrive rather than holding the personal-communication-device 36 in the air as suggested in FIG. 1. It is also contemplated that the identification-code 24 could be a permanent unique (i.e. personalized) symbol or figure attached to (i.e. sewn on) one of the above examples of well-known travel equipment. In this case the identification-code 24 may be communicated from the client 14 to the dispatch-center 20 in the form of a photograph or illustration of the symbol that may be unique to the client 14.

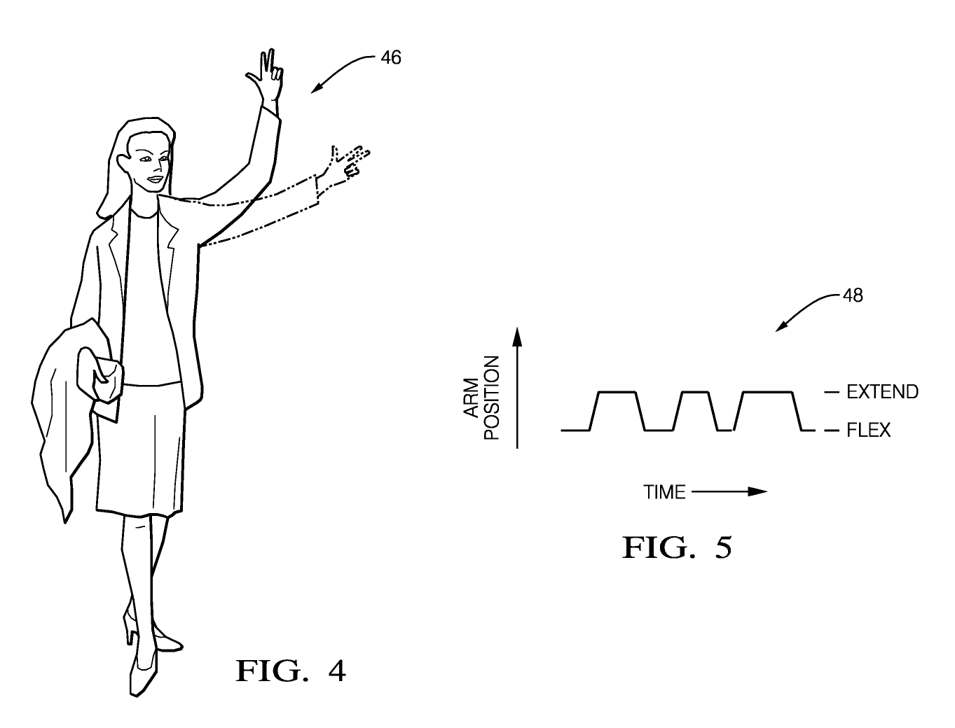

FIG. 4 illustrates another non-limiting example where the identification-code 24 may be displayed by a gesture 46 performed by the client 14. The gesture 46 may include the client indicating a number using fingers of the hand of the client 14. By way of a non-limiting example, the client may indicate the number ‘three’ by extending the thumb, index-finger, and middle-finger. The gesture 46 may also be or include and a waving-pattern 48 (FIG. 5) where the client 14 alternatingly flexes and extends a forearm overhead. It is contemplated that the timing or sequence of flexing and extending may be done by the client 14 in response to instructions (e.g. a tone or voice command) provided by the personal-communication-device 36. Other examples of the gesture 46 are contemplated such as, but not limited to, the client 14 patting him or herself on their head or extending both arms overhead.

It is contemplated that situations may arise where the location of the client 14 is not suitable or not preferred to pick up the client 14. For example, the baggage of the client 14 may be located some distance from the location 50, either within or outside of, the previously designated or agreed upon instance of the pickup-zone 22. Several options are contemplated for changing the location 50 after the automated taxi 12 has identified the client 14. One option is for the client 14 may simply walk towards an alternative location where the client wishes to be picked up. The automated-taxi 12 then follows the client to a new instance of a pickup-spot when the client 14 moves away from the location 50. The client 14 may gesture or operate the personal-communication-device 36 to displays a follow-me message after the system 10 notifies the client 14 that the location 50 of the client has been determined, and the automated-taxi follows the client to a pickup-spot when the client moves away from the location 50.

Accordingly, an automated-taxi client identification system (the system 10), a controller 32 for the system 10, and a method of operating the system 10 is provided. The system 10 provides the means for the automated-taxi 12 to identify the client 14, which may be particularly useful when the client 14 is in a crowd. The system 10 also provides the means for the actual pick-up site to be moved by the client 14 after the automated-taxi 12 has identified the client 14.

While this invention has been described in terms of the preferred embodiments thereof, it is not intended to be so limited, but rather only to the extent set forth in the claims that follow.

We claim:

1. An automated-taxi client identification system for automated vehicles, said system comprising:
a communications-network used to send a transportation-request from a client to an automated-taxi, and communicate an identification-code to be displayed by the client;
a camera used by the automated-taxi to capture an image of a pickup-zone; and
a controller in communication with the camera and the communications-network, wherein the controller determines when the identification-code is detected in the image and determines a location of the client based on a position of the identification-code in the image.

2. The system in accordance with claim 1, wherein the identification-code is displayed on a personal-communications-device operated by the client.

3. The system in accordance with claim 2, wherein the identification-code includes one of a light-pulse-sequence, a color, a color-pattern, and a color-sequence.

4. The system in accordance with claim 1, wherein the identification-code is displayed by a gesture performed by the client.

5. The system in accordance with claim 4, wherein the gesture includes one of indicating a number using fingers on a hand of the client and a waving-pattern.

6. The system in accordance with claim 1, wherein the automated-taxi follows the client to a pickup-spot when the client moves away from the location.

7. The system in accordance with claim 1, wherein the system notifies the client when the location of the client has been determined.

8. The system in accordance with claim 7, wherein the client displays a follow-me message after the system notifies the client that the location of the client has been determined, and the automated-taxi follows the client to a pickup-spot when the client moves away from the location.
